(19) United States
(12) Patent Application Publication
(10) Pub. No.: US 2017/0199558 A1
(43) Pub. Date: Jul. 13, 2017

(54) FLEXIBLE AND SCALABLE ENERGY MODEL FOR ESTIMATING ENERGY CONSUMPTION

(71) Applicant: QUALCOMM Incorporated, San Diego, CA (US)

(72) Inventors: Navid Farazmand, Marlborough, MA (US); Anish Muttreja, San Diego, CA (US); Eduardus Antonius Metz, Unionville (CA); Lucille Garwood Sylvester, Boulder, CO (US); Brian Salsbery, Superior, CO (US)

(21) Appl. No.: 15/238,267

(22) Filed: Aug. 16, 2016

Related U.S. Application Data
(60) Provisional application No. 62/277,383, filed on Jan. 11, 2016.

(51) Int. Cl. G06F 1/32

(52) U.S. Cl. CPC G06F 1/3206; G09G 2330/02

(57) ABSTRACT

At least one processor may determine, for each of a plurality of operating performance points (OPPs) that each comprise a memory frequency and a graphics processing unit (GPU) frequency, an estimated energy consumption associated with a memory and the GPU operating at the respective memory frequency and GPU frequency to process a workload based at least in part on a plurality of energy equations associated with the plurality of OPPs. The at least one processor may set the memory and the GPU to operate at the respective memory frequency and GPU frequency of one of the plurality of OPPs to process the workload based at least in part on the estimated energy consumption.

### RELATED APPLICATIONS

This application claims the benefit of U.S. Provisional Application Ser. No. 62/277,383, filed Jan. 11, 2016, the entire contents of which is hereby incorporated by reference herein.

### TECHNICAL FIELD

This disclosure relates to estimating the energy consumption of a processing unit and an associated memory for a given workload.

### BACKGROUND

Mobile devices are powered by batteries of limited size and/or capacity. Typically, mobile devices are used for making phone calls, checking email, recording/playback of a picture/video, listening to radio, navigation, web browsing, playing games, managing devices, and performing calculations, among other things. Many of these actions utilize a graphics processing unit (GPU) to perform some tasks. Example GPU tasks include the rendering of content to a display and performing general compute computations (e.g., in a general purpose GPU (GPGPU) operation). Therefore, the GPU is typically a large consumer of power in mobile devices. As such, it is beneficial to manage the power consumption of the GPU in order to prolong battery life.

### SUMMARY

In general, the disclosure describes techniques for determining an estimated energy consumption of a computing system based at least in part on the operating frequencies of a graphics processing unit (GPU) and a system memory of the computing system.

In one aspect of the disclosure, a method includes determining, by at least one processor for each of a plurality of operating performance points (OPPs) that each comprise a memory frequency and a graphics processing unit (GPU) frequency, an estimated energy consumption associated with a memory and a GPU operating at the respective memory frequency and GPU frequency to process a workload based at least in part on a plurality of energy equations associated with the plurality of OPPs. The method further includes setting the memory and the GPU to operate at the respective memory frequency and GPU frequency of one of the plurality of OPPs to process the workload based at least in part on the estimated energy consumption.

In another aspect of the disclosure, a device includes a graphics processing unit (GPU). The device further includes a memory operably coupled to the GPU. The device further includes at least one processor configured to: determine, for each of a plurality of operating performance points (OPPs) that each comprise a memory frequency and a GPU frequency, an estimated energy consumption associated with the memory and the GPU operating at the respective memory frequency and GPU frequency to process a workload based at least in part on a plurality of energy equations associated with the plurality of OPPs; and set the memory and the GPU to operate at the respective memory frequency and GPU frequency of one of the plurality of OPPs to process the workload based at least in part on the estimated energy consumption.

In another aspect of the disclosure, an apparatus includes means for determining, for each of a plurality of operating performance points (OPPs) that each comprise a memory frequency and a graphics processing unit (GPU) frequency, an estimated energy consumption associated with a memory and a GPU operating at the respective memory frequency and GPU frequency to process a workload based at least in part on a plurality of energy equations associated with the plurality of OPPs. The apparatus further includes means for setting the memory and the GPU to operate at the respective memory frequency and GPU frequency of one of the plurality of OPPs to process the workload based at least in part on the estimated energy consumption.

In another aspect of the disclosure, a non-transitory computer-readable storage medium includes instructions that, when executed on at least one processor, causes the at least one processor to: determine, for each of a plurality of operating performance points (OPPs) that each comprise a memory frequency and a graphics processing unit (GPU) frequency, an estimated energy consumption associated with a memory and a GPU operating at the respective memory frequency and GPU frequency to process a workload based at least in part on a plurality of energy equations associated with the plurality of OPPs; and set the memory and the GPU to operate at the respective memory frequency and GPU frequency of one of the plurality of OPPs to process the workload based at least in part on the estimated energy consumption.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example device for processing data in accordance with one or more example techniques described in this disclosure.

FIG. 2 is a block diagram illustrating components of the device illustrated in FIG. 1 in greater detail.

FIG. 3 is a block diagram illustrating an example implementation of a graphics system which may determine an optimal OPP at which to operate an example GPU and an example memory to process an example workload.

FIG. 4 is a block diagram illustrating an exemplary energy model that may be utilized to determine estimated energy consumption for an example GPU and an example memory operating according to various operating frequencies.

FIG. 5 is a flowchart illustrating an example automated energy model generation methodology.

FIG. 6 is a flowchart illustrating a process for estimating energy consumption by a GPU and a memory at a given OPP.

### DETAILED DESCRIPTION

A computing system may include a processing unit, such as a graphics processing unit (GPU), that includes an internal clock that sets the rate at which the GPU processes instructions (e.g., sets the operation frequency of the GPU). The GPU may transfer data to and from memory that also includes or otherwise utilizes (e.g., via a memory controller) a memory clock that sets the rate at which the memory may transfer data.

In some examples, a host processor (e.g., central processing unit (CPU)) may determine an optimal clock rate and/or operating voltage at which the GPU and the memory should operate by performing dynamic clock and voltage scaling (DCVS). The host processor may attempt to set the operation frequency of the GPU and the memory to keep power consumption low without impacting the GPU's timely completion of processing instructions. In other examples, one or more processors other than the host processor may perform DCVS to determine the optimal clock rate and/or operating voltage which the GPU and the memory should operate. For example, firmware of a processing unit dedicated to power management/scheduling within the GPU may be able to perform DCVS. Thus, while the application describes a variety of examples in which a host processor (e.g., a CPU) that may be able to perform example DCVS techniques, it should be understood that such exemplary DCVS techniques may equally be performed by one or more processors other than the host processor.

Some example DCVS techniques may rely on performance metrics as a proxy for energy consumption. Such approaches are potentially becoming less optimal as power management solutions evolve and become more complicated. Process technology advancements and the static vs. dynamic power consumption ratio also add to the complications. For example, it may not always be the case that a GPU and memory operating at a lower GPU frequency and memory frequency necessarily consume less energy than a GPU and memory operating at a relatively higher GPU frequency and memory frequency. Thus, in some instances, the computing system may be able to complete tasks more quickly while expending less energy by operating at a relatively higher GPU frequency and memory frequency.

To estimate the energy consumption of a computing system operating at a particular GPU and memory operating frequencies, aspects of this disclosure are directed to an energy model that estimates the energy consumption given a specific workload and DCVS Operating Performance Point (OPP). An OPP may be a pair of operating frequencies, including the operating frequency of a GPU (i.e., GPU clock rate) as well as the operating frequency of memory (i.e., memory clock rate). For a given GPU and memory frequency pair and the specific workload of the GPU, the host processor may utilize an energy model to estimate the energy consumption of the workload at the given GPU and memory frequencies. In some examples, a workload may be the commands making up one or more shader programs that the GPU may execute.

In some examples, estimating the energy consumption of the computing system may include estimating the total graphics (GPU) and memory energy consumption. In some examples, estimating the energy consumption of the computing system may include estimating the system on chip energy consumption (at the battery) that includes the GPU and memory. In other examples, estimating the energy consumption may include estimating the energy consumption of any suitable combination of the power rails that may be included in the energy model, as long as it is based on the corresponding GPU and memory operating frequencies.

Proposed devices and techniques disclosed herein include creating a set of statistically-derived equations that define the energy model. Specifically, a separate energy equation may be created for each different OPP. The host processor may utilize the energy model to determine an optimal operating frequency for the GPU and the memory, and to readjust initial frequency sets to the optimal frequency level for sustained performance with the lowest power consumption.

In other words, the host processor may determine an optimal pairing of operating frequencies at which the GPU and the memory operates, based at least in part on the performance requirements of a workload that is to be processed by the GPU. The host processor may determine, based at least in part on a performance model, a plurality of GPU frequency and memory frequency pairs that may meet the performance requirements of the workload when processing the workload.

For each of the plurality of GPU frequency and memory frequency pairs that the host processor determines would meet the performance requirements, the host processor may utilize the energy model to estimate an energy consumption to process the workload. The host processor may select one of the plurality of GPU frequency and memory frequency pairs as being an optimal OPP based at least in part on the energy model. For example, the GPU may determine the optimal OPP to be the GPU frequency and memory frequency pair at which the GPU and the memory respective operates to process the workload that would consume the least amount of energy out of the plurality of GPU frequency and memory frequency pairs. The host processor may configure the GPU and the memory to operate at the determined optimal OPP to process the workload.

The techniques disclosed herein may be broadly applicable to a wide range of processors, devices, circuitry, logic, and the like. For example, the techniques disclosed herein may determine an optimal pairing of operating frequencies for memory and any suitable processor (e.g., CPU, digital signal processor, and the like). As such, the techniques disclosed herein are in no way only directed to GPUs. While this disclosure discusses various techniques in terms of determining an optimal operating frequency for a GPU, it should be understood that the same techniques may be equally applicable to determining an optimal operating frequency for any suitable processor.

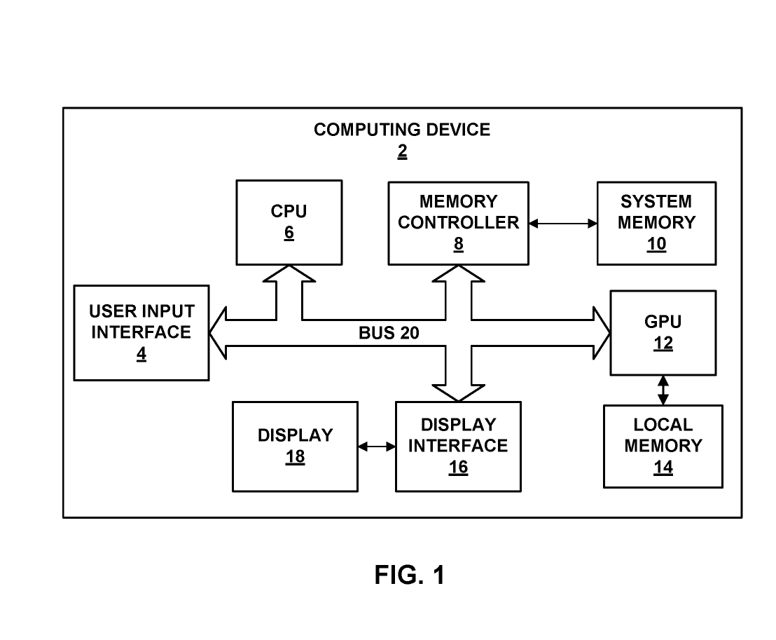

FIG. 1 is a block diagram illustrating an example computing device 2 that may be used to implement techniques of this disclosure. Computing device 2 may comprise a personal computer, a desktop computer, a laptop computer, a computer workstation, a video game platform or console, a wireless communication device (such as, e.g., a mobile telephone, a cellular telephone, a satellite telephone, and/or a mobile telephone handset), a landline telephone, an Internet telephone, a handheld device such as a portable video game device or a personal digital assistant (PDA), a personal music player, a video player, a display device, a television, a television set-top box, a server, an intermediate network device, a mainframe computer or any other type of device that processes and/or displays graphical data.

As illustrated in the example of FIG. 1, computing device 2 includes a user input interface 4, a CPU 6, a memory controller 8, a system memory 10, a graphics processing unit (GPU) 12, a local memory 14, a display interface 16, a display 18 and bus 20. User input interface 4, CPU 6, memory controller 8, GPU 12 and display interface 16 may communicate with each other using bus 20. Bus 20 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXentisible Interface (AXI) bus) or another type of bus or device interconnect. It should be noted that the specific configuration of buses and communication interfaces between the different components shown in FIG. 1 is merely exemplary, and other configurations of computing devices and/or other graphics processing systems with the same or different components may be used to implement the techniques of this disclosure.

CPU 6 may comprise a general-purpose or a special-purpose processor that controls operation of computing device 2. A user may provide input to computing device 2 to cause CPU 6 to execute one or more software applications. The software applications that execute on CPU 6 may include, for example, an operating system, a word processor application, an email application, a spread sheet application, a media player application, a video game application, a graphical user interface application or another program. The user may provide input to computing device 2 via one or more input devices (not shown) such as a keyboard, a mouse, a microphone, a touch pad or another input device that is coupled to computing device 2 via user input interface 4.

The software applications that execute on CPU 6 may include one or more graphics rendering instructions that instruct CPU 6 to cause the rendering of graphics data to display 18. In some examples, the software instructions may conform to a graphics application programming interface (API), such as, e.g., an Open Graphics Library (OpenGL®) API, an Open Graphics Library Embedded Systems (OpenGL ES) API, an OpenCL API, a Direct3D API, an X3D API, a RenderMan API, a WebGL API, or any other public or proprietary standard graphics API. The techniques should not be considered limited to requiring a particular API.

In order to process the graphics rendering instructions, CPU 6 may issue one or more graphics rendering commands to GPU 12 to cause GPU 12 to perform some or all of the rendering of the graphics data. In some examples, the graphics data to be rendered may include a list of graphics primitives, e.g., points, lines, triangles, quadralaterals, triangle strips, etc.

Memory controller 8 facilitates the transfer of data going into and out of system memory 10. For example, memory controller 8 may receive memory read and write commands, and service such commands with respect to system memory 10 in order to provide memory services for the components in computing device 2. Memory controller 8 is communicatively coupled to system memory 10. Although memory controller 8 is illustrated in the example computing device 2 of FIG. 1 as being a processing module that is separate from both CPU 6 and system memory 10, in other examples, some or all of the functionality of memory controller 8 may be implemented on one or both of CPU 6 and system memory 10.

System memory 10 may store program modules and/or instructions that are accessible for execution by CPU 6 and/or data for use by the programs executing on CPU 6. For example, system memory 10 may store user applications and graphics data associated with the applications. System memory 10 may additionally store information for use by and/or generated by other components of computing device 2. For example, system memory 10 may act as a device memory for GPU 12 and may store data to be operated on by GPU 12 as well as data resulting from operations performed by GPU 12. For example, system memory 10 may store any combination of texture buffers, depth buffers, stencil buffers, vertex buffers, frame buffers, or the like. In addition, system memory 10 may store command streams for processing by GPU 12. System memory 10 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 10 may include instructions that cause CPU 6 and/or GPU 12 to perform the functions ascribed in this disclosure to CPU 6 and GPU 12. Accordingly, system memory 10 may be a computer-readable storage medium having instructions stored thereon that, when executed, cause one or more processors (e.g., CPU 6 and GPU 12) to perform various functions. Further, system memory 10 may be operably coupled to CPU 6 and/or GPU 12, such as via bus 20.

In some examples, system memory 10 is a non-transitory storage medium. The term “non-transitory” indicates that the storage medium is not embodied in a carrier wave or a propagated signal. However, the term “non-transitory” should not be interpreted to mean that system memory 10 is non-movable or that its contents are static. As one example, system memory 10 may be removed from computing device 2, and moved to another device. As another example, memory, substantially similar to system memory 10, may be inserted into computing device 2. In certain examples, a non-transitory storage medium may store data that can, over time, change (e.g., in RAM).

GPU 12 may be configured to perform graphics operations to render one or more graphics primitives to display 18. Thus, when one of the software applications executing on CPU 6 requires graphics processing, CPU 6 may provide graphics commands and graphics data to GPU 12 for rendering to display 18. The graphics commands may include, e.g., drawing commands such as a draw call, GPU state programming commands, memory transfer commands, general-purpose computing commands, kernel execution commands, etc. In some examples, CPU 6 may provide the commands and graphics data to GPU 12 by writing the commands and graphics data to memory 10, which may be accessed by GPU 12. In some examples, GPU 12 may be further configured to perform general-purpose computing for applications executing on CPU 6.

GPU 12 may, in some instances, be built with a highly-parallel structure that provides more efficient processing of vector operations than CPU 6. For example, GPU 12 may include a plurality of processing elements that are configured to operate on multiple vertices or pixels in a parallel manner. The highly parallel nature of GPU 12 may, in some instances, allow GPU 12 to draw graphics images (e.g., GUIs and two-dimensional (2D) and/or three-dimensional (3D) graphics scenes) onto display 18 more quickly than drawing the scenes directly to display 18 using CPU 6. In addition, the highly parallel nature of GPU 12 may allow GPU 12 to process certain types of vector and matrix operations for general-purpose computing applications more quickly than CPU 6.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. In further instances, GPU 12 may be located on the same microchip as CPU 6 forming a system on a chip (SoC). GPU 12 and CPU 6 may include one or more processors, such as one or more microprocessors, application specific integrated circuits (ASICs), field programmable gate arrays (FPGAs), digital signal processors (DSPs), or other equivalent integrated or discrete logic circuitry.

GPU 12 may be directly coupled to local memory 14. Thus, GPU 12 may read data from and write data to local memory 14 without necessarily using bus 20. In other words, GPU 12 may process data locally using a local storage, instead of off-chip memory. This allows GPU 12 to operate in a more efficient manner by eliminating the need of GPU 12 to read and write data via bus 20, which may experience heavy bus traffic. In some instances, however, GPU 12 may not include a separate cache, but instead utilize system memory 10 via bus 20. Local memory 14 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media.

CPU 6 and/or GPU 12 may store rendered image data in a frame buffer that is allocated within system memory 10. Display interface 16 may retrieve the data from the frame buffer and configure display 18 to display the image represented by the rendered image data. In some examples, display interface 16 may include a digital-to-analog converter (DAC) that is configured to convert the digital values retrieved from the frame buffer into an analog signal consumable by display 18. In other examples, display interface 16 may pass the digital values directly to display 18 for processing. Display 18 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 18 may be integrated within computing device 2. For instance, display 18 may be a screen of a mobile telephone handset or a tablet computer. Alternatively, display 18 may be a stand-alone device coupled to computing device 2 via a wired or wireless communications link. For instance, display 18 may be a computer monitor or flat panel display connected to a personal computer via a cable or wireless link.

As described, CPU 6 may offload graphics processing to GPU 12, such as tasks that require massive parallel operations. As one example, graphics processing requires massive parallel operations, and CPU 6 may offload such graphics processing tasks to GPU 12. However, other operations such as matrix operations may also benefit from the parallel processing capabilities of GPU 12. In these examples, CPU 6 may leverage the parallel processing capabilities of GPU 12 to cause GPU 12 to perform non-graphics related operations.

In the techniques described in this disclosure, a first processing unit (e.g., CPU 6) offloads certain tasks to a second processing unit (e.g., GPU 12). To offload tasks, CPU 6 outputs commands to be executed by GPU 12 and data that are operands of the commands (e.g., data on which the commands operate) to system memory 10 and/or directly to GPU 12. GPU 12 receives the commands and data, directly from CPU 6 and/or from system memory 10, and executes the commands. In some examples, rather than storing commands to be executed by GPU 12, and the data operands for the commands, in system memory 10, CPU 6 may store the commands and data operands in a local memory that is local to the IC that includes GPU 12 and CPU 6 and shared by both CPU 6 and GPU 12 (e.g., local memory 14). In general, the techniques described in this disclosure are applicable to the various ways in which CPU 6 may make available the commands for execution on GPU 12, and the techniques are not limited to the above examples.

The rate at which GPU 12 executes the commands is set by the frequency of a clock signal (also referred to as a clock rate, operating frequency, or GPU frequency, of GPU 12). For example, GPU 12 may execute a command every rising or falling edge of the clock signal, or execute one command every rising edge and another command every falling edge of the clock signal. Accordingly, how often a rising or falling edge of the clock signal occurs within a time period (e.g., frequency of the clock signal) sets how many commands GPU 12 executes within the time period.

Similarly, memory in computing device 2, such as system memory 10 and/or local memory 14, may also have an associated frequency of a clock signal (also referred to as a clock rate, operating frequency, or memory frequency). The clock rate of the memory controls the bus bandwidth of bus 20, and may set how much data can be sent or received from system memory 10 and/or local memory 14 via bus 20. For example, the memory may transfer a portion of data to or from the memory every rising or falling edge of the clock signal. If the memory transfers a portion of data at both the rising edge and falling edges of the clock signal, the memory may be referred to as a double data rate (DDR) memory. Accordingly, how often a rising or falling edge of the clock signal occurs within a time period (e.g., frequency of the clock signal) sets how much data the memory transfers within the time period.

In some examples, such as those where CPU 6 stores commands to be executed by GPU 12 in memory (e.g., system memory 10 or local memory 14), CPU 6 may output memory address information identifying a group of commands that GPU 12 is to execute. The group of commands that GPU 12 is to execute is referred to as submitted commands. In examples where CPU 6 directly outputs the commands to GPU 12, the submitted commands includes those commands that CPU 6 instructs GPU 12 to execute immediately.

There may be various ways in which CPU 6 may group commands to be executed by GPU 12. As one example, a group of commands includes all the commands needed by GPU 12 to render one frame. If commands are grouped in such a way, the commands may be considered as being grouped at “frame granularity.” As another example, a group of commands may be so-called “atomic commands” that are to be executed together without GPU 12 switching to other commands. Other ways to group commands that are submitted to GPU 12 may be possible, and the disclosure is not limited to the above example techniques. A group of commands, as grouped by CPU 6, may be referred to as a workload. Thus, if commands are grouped at frame granularity, then a workload may refer to a group of commands that GPU 12 may execute to render one frame.

A frame, as used in this disclosure, refers to a full image that can be presented, such as via display 18. The frame includes a plurality of pixels that represent graphical content, with each pixel having a pixel value. For instance, after GPU 12 renders a frame, GPU 12 stores the resulting pixel values of the pixels of the frame in a frame buffer, which may be in system memory 10. Display interface 16 receives the pixel values of the pixels of the frame from the frame buffer and outputs values based on the pixel values to cause display 18 to display the graphical content of the frame. In some examples, display interface 16 causes display 18 to display frames at a rate of 60 frames per second (fps) (e.g., a frame is displayed approximately every 16.67 ms), 24 fps, 30 fps, 120 fps, and the like.

In some cases, GPU 12 may need to execute the submitted commands within a set time period. The number of commands GPU 12 may need to execute within a set time period may be referred to as a “performance requirement” for GPU 12. For instance, computing device 2 may be handheld device, where display 18 also functions as the user interface. As one example, to achieve a stutter free (also referred to as jank-free) user interface, GPU 12 may need to complete execution of the submitted commands within approximately 16 milliseconds (ms), assuming a frame rate of 60 frames per second (other time periods are possible).

The amount of commands that CPU 6 submits and the timing of when CPU 6 submits commands need not necessarily be constant. As such, the operating frequencies of GPU 12 and memory 10 may be increased or decreased so that GPU 12 is able to execute the commands within the set time period, without unnecessarily increasing power consumption. The amount of commands GPU 12 needs to execute within the set time period may change because there are more or fewer commands in a group of commands that need to be executed within the set time period, because there is an increase or decrease in the number of groups of commands that need to be executed within the set time period, or a combination of the two.

If the operating frequencies of GPU 12 and memory 10 were permanently kept at a relatively high frequency, then GPU 12 would be able to timely execute the submitted commands in most instances. However, executing commands at a relatively high frequency may increase the energy consumption of GPU 12 and memory 10. Further, as discussed above, in some instances, GPU 12 and memory 10 may be able to meet a performance requirement while operating at a relatively low frequency. If the operating frequencies of GPU 12 and memory 10 were permanently kept at a relatively low frequency, then the energy consumption of GPU 12 and memory 10 may be reduced, but GPU 12 may not be able to timely execute submitted commands in most instances, leading to janky behavior and possibly other unwanted effects.

In accordance with aspects of the present disclosure, CPU 6 may determine an optimal OPP for GPU 12 and memory 10 to process an upcoming workload to meet a performance requirement while minimizing the energy consumption of GPU 12 and memory 10. In the example of GPU 12 processing commands to render frames of a video or animated image (i.e., a sequence of image frames) that are displayed by display 18, CPU 6 may determine the optimal pairing of operating frequency for GPU 12 and operating frequency for memory 10 at which GPU 12 12 and memory 10 may operate when processing an upcoming image frame of the sequence of image frames in order to render the image frame by a particular rendering deadline, while minimizing the energy consumed by GPU 12 and memory 10 to process the upcoming image frame.

CPU 6 may execute a performance model to determine a set of OPPs for GPU 12 and memory 10 that meets the performance requirement for the upcoming workload. CPU 6 may further, for each OPP in the set of OPPs, determine an estimated energy consumption to process the upcoming workload, based at least in part on a separate energy equation for each OPP. CPU 6 may, based at least in part on the estimated energy consumption determined by CPU 6, select an OPP at which GPU 12 and memory 10 consumes the least amount of energy as the optimal OPP for performing the upcoming workload.

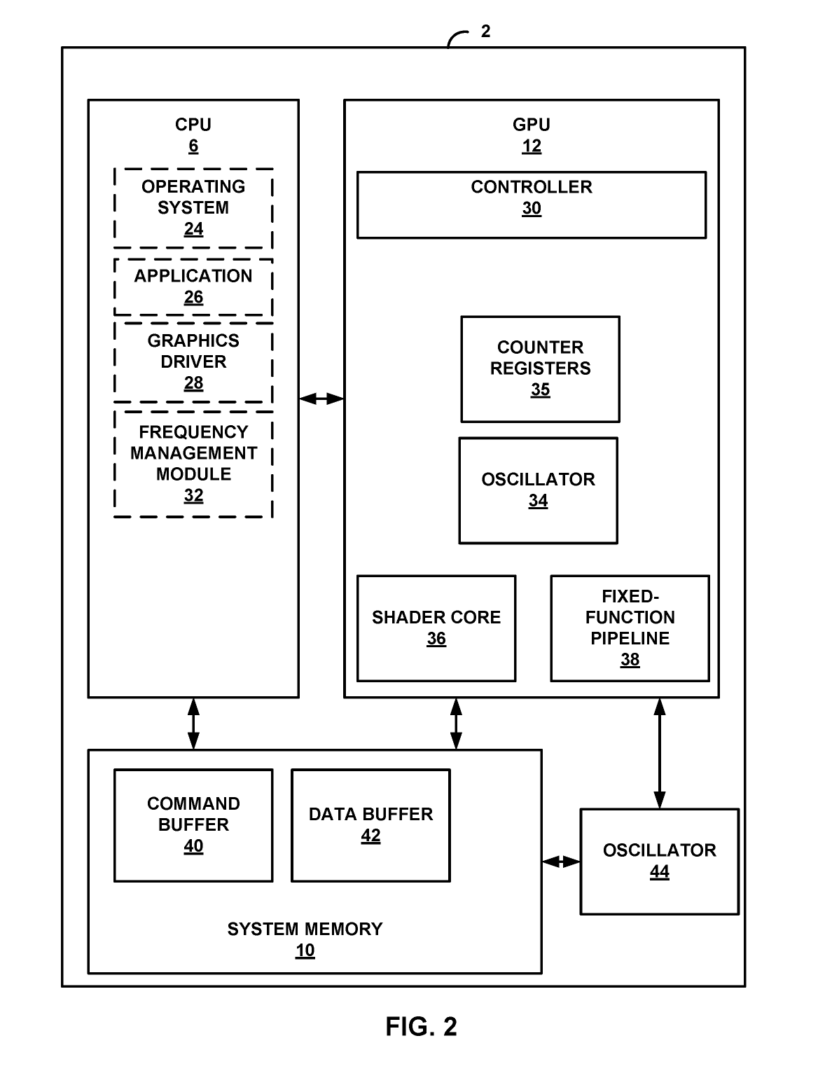

FIG. 2 is a block diagram illustrating components of the device illustrated in FIG. 1 in greater detail. As illustrated in FIG. 2, GPU 12 includes controller 30, oscillator 34, counter registers 35, shader core 36, and fixed-function pipeline 38. Shader core 36 and fixed-function pipeline 38 may together form an execution pipeline used to perform graphics or non-graphics related functions. Although only one shader core 36 is illustrated, in some examples, GPU 12 may include one or more shader cores similar to shader core 36.

The commands that GPU 12 is to execute are executed by shader core 36 and fixed-function pipeline 38, as determined by controller 30 of GPU 12. Controller 30 may be implemented as hardware on GPU 12 or software or firmware executing on hardware of GPU 12.

Controller 30 may receive commands that are to be executed for rendering a frame from command buffer 40 of system memory 10 or directly from CPU 6 (e.g., receive the submitted commands that CPU 6 determined should now be executed by GPU 12). Controller 30 may also retrieve the operand data for the commands from data buffer 42 of system memory 10 or directly from CPU 6. For example, command buffer 40 may store a command to add A and B. Controller 30 retrieves this command from command buffer 40 and retrieves the values of A and B from data buffer 42. Controller 30 may determine which commands are to be executed by shader core 36 (e.g., software instructions are executed on shader core 36) and which commands are to be executed by fixed-function pipeline 38 (e.g., commands for units of fixed-function pipeline 38).

In some examples, commands and/or data from one or both of command buffer 40 and data buffer 42 may be part of local memory 14 of GPU 12. For instance, GPU 12 may include an instruction cache and a data cache, which may be part of local memory 14 that stores commands from command buffer 40 and data from data buffer 42, respectively. In these examples, controller 30 may retrieve the commands and/or data from local memory 14.

Shader core 36 and fixed-function pipeline 38 may transmit and receive data from one another. For instance, some of the commands that shader core 36 executes may produce intermediate data that are operands for the commands that units of fixed-function pipeline 38 are to execute. Similarly, some of the commands that units of fixed-function pipeline 38 execute may produce intermediate data that are operands for the commands that shader core 36 is to execute. In this way, the received data is progressively processed through units of fixed-function pipeline 38 and shader core 36 in a pipelined fashion. Hence, shader core 36 and fixed-function pipeline 38 may be referred to as implementing an execution pipeline.

In general, shader core 36 allows for various types of commands to be executed, meaning that shader core 36 is programmable and provides users with functional flexibility because a user can program shader core 36 to perform desired tasks in most conceivable manners. The fixed-function units of fixed-function pipeline 38, however, are hardwired for the manner in which the fixed-function units perform tasks. Accordingly, the fixed-function units may not provide much functional flexibility.

As also illustrated in FIG. 2, GPU 12 includes oscillator 34. Oscillator 34 outputs a clock signal that sets the time instances when shader core 36 and/or units of fixed-function pipeline 38 execute commands. Although oscillator 34 is illustrated as being internal to GPU 12, in some examples, oscillator 34 may be external to GPU 12. Also, oscillator 34 need not necessarily just provide the clock signal for GPU 12, and may provide the clock signal for other components as well. Oscillator 34 may generate a square wave, a sine wave, a triangular wave, or other types of periodic waves. Oscillator 34 may include an amplifier to amplify the voltage of the generated wave, and output the resulting wave as the clock signal for GPU 12.

In some examples, on a rising edge or falling edge of the clock signal outputted by oscillator 34, shader core 36 and each unit of fixed-function pipeline 38 may execute one command. In some cases, a command may be divided into sub-commands, and shader core 36 and each unit of fixed-function pipeline 38 may execute a sub-command in response to a rising or falling edge of the clock signal. For instance, the command of A+B includes the sub-commands to retrieve the value of A and the value of B, and shader core 36 or fixed-function pipeline 38 may execute each of these sub-commands at a rising edge or falling edge of the clock signal.

The rate at which shader core 36 and units of fixed-function pipeline 38 execute commands may affect the power consumption of GPU 12. For example, if the frequency of the clock signal outputted by oscillator 34 is relatively high, shader core 36 and the units of fixed-function pipeline 38 may execute more commands within a time period as compared the number of commands shader core 36 and the units of fixed-function pipeline 38 would execute for a relatively low frequency of the clock signal. However, the power consumption of GPU 12 may, in some examples, be greater in instances where shader core 36 and the units of fixed-function pipeline 38 are executing more commands in the period of time (due to the higher frequency of the clock signal from oscillator 34) than compared to instances where shader core 36 and the units of fixed-function pipeline 38 are executing fewer commands in the period of time (due to the lower frequency of the clock signal from oscillator 34).

In some examples, the frequency of the clock signal outputted by oscillator 34 is a function of the voltage applied to oscillator 34 (which may be the same as the voltage applied to GPU 12, but not necessary in every example). For instance, the frequency of the clock signal outputted by oscillator 34 is higher for a higher voltage than the frequency of the clock signal outputted by oscillator 34 for a lower voltage. Accordingly, the frequency of the clock signal outputted by oscillator 34 is a function of the power consumption of oscillator 34 (or GPU 12 more generally). By controlling the frequency of the clock signal outputted by oscillator 34, CPU 6 may control the overall power consumption.

As described above, CPU 6 may offload tasks to GPU 12 due to the massive parallel processing capabilities of GPU 12. For instance, GPU 12 may be designed with a single instruction, multiple data (SIMD) structure. In the SIMD structure, shader core 36 includes a plurality of SIMD processing elements, where each SIMD processing element executes same commands, but on different data.

A particular command executing on a particular SIMD processing element is referred to as a thread. Each SIMD processing element may be considered as executing a different thread because the data for a given thread may be different; however, the thread executing on a processing element is the same command as the command executing on the other processing elements. In this way, the SIMD structure allows GPU 12 to perform many tasks in parallel (e.g., at the same time). For such SIMD structured GPU 12, each SIMD processing element may execute one thread on a rising edge or falling edge of the clock signal.

To avoid confusion, this disclosure uses the term “command” to generically refer to a process that is executed by shader core 36 or units of fixed-function pipeline 38. For instance, a command includes an actual command, constituent sub-commands (e.g., memory call commands), a thread, or other ways in which GPU 12 performs a particular function. Because GPU 12 includes shader core 36 and fixed-function pipeline 38, GPU 12 may be considered as executing the commands.

Also, in the above examples, shader core 36 or units of fixed-function pipeline 38 execute a command in response to a rising or falling edge of the clock signal outputted by oscillator 34. However, in some examples, shader core 36 or units of fixed-function pipeline 38 may execute one command on a rising edge and another, subsequent command on a falling edge of the clock signal. There may be other ways in which to “clock” the commands, and the techniques described in this disclosure are not limited to the above examples.

Because GPU 12 executes commands every rising edge, falling edge, or both, the frequency of clock signal (also referred to as clock rate) outputted by oscillator 34 sets the amount of commands GPU 12 can execute within a certain time. For instance, if GPU 12 executes one command per rising edge of the clock signal, and the frequency of the clock signal is 1 MHz, then GPU 12 can execute one million commands in one second.

As illustrated in FIG. 2, CPU 6 executes application 26, as illustrated by the dashed boxes. During execution, application 26 generates commands that are to be executed GPU 12, including commands that instruct GPU 12 to retrieve and execute shader programs (e.g., vertex shaders, fragment shaders, compute shaders for non-graphics applications, and the like). In addition, application 26 generates the data on which the commands operate (i.e., the operands for the commands). CPU 6 stores the generated commands in command buffer 40, and stores the operand data in data buffer 42.

After CPU 6 stores the generated commands in command buffer 40, CPU 6 makes available the commands for execution by GPU 12. For instance, CPU 6 communicates to GPU 12 the memory addresses of a set of the stored commands and their operand data and information indicating when GPU 12 is to execute the set of commands. In this way, CPU 6 submits commands to GPU 12 for executing to render a frame.

As illustrated in FIG. 2, CPU 6 may also execute graphics driver 28. In some examples, graphics driver 28 may be software or firmware executing on hardware or hardware units of CPU 6. Graphics driver 28 may be configured to allow CPU 6 and GPU 12 to communicate with one another. For instance, when CPU 6 offloads graphics or non-graphics processing tasks to GPU 12, CPU 6 offloads such processing tasks to GPU 12 via graphics driver 28. For example, when CPU 6 outputs information indicating the amount of commands GPU 12 is to execute, graphics driver 28 may be the unit of CPU 6 that outputs the information to GPU 12.

As additional examples, application 26 produces graphics data and graphics commands, and CPU 6 may offload the processing of this graphics data to GPU 12. In this example, CPU 6 may store the graphics data in data buffer 42 and the graphics commands in command buffer 40, and graphics driver 28 may instruct GPU 12 when to retrieve the graphics data and graphics commands from data buffer 42 and command buffer 40, respectively, from where to retrieve the graphics data and graphics commands from data buffer 42 and command buffer 40, respectively, and when to process the graphics data by executing one or more commands of the set of commands.

Also, application 26 may require GPU 12 to execute one or more shader programs. For instance, application 26 may require shader core 36 to execute a vertex shader and a fragment shader to generate pixel values for the frames that are to be displayed (e.g., on display 18 of FIG. 1). Graphics driver 28 may instruct GPU 12 when to execute the shader programs and instruct GPU 12 with where to retrieve the graphics data from data buffer 42 and where to retrieve the commands from command buffer 40 or from other locations in system memory 10. In this way, graphics driver 28 may form a link between CPU 6 and GPU 12.

Graphics driver 28 may be configured in accordance to an application processing interface (API); although graphics driver 28 does not need to be limited to being configured in accordance with a particular API. In an example where computing device 2 is a mobile device, graphics driver 28 may be configured in accordance with the OpenGL ES API. The OpenGL ES API is specifically designed for mobile devices. In an example where computing device 2 is a non-mobile device, graphics driver 28 may be configured in accordance with the OpenGL API.

The amount of commands in the submitted commands may be based on the commands needed to render one or more frames of the user-interface or gaming application. For the user-interface example, GPU 12 may need to execute the commands needed to render one frame of the user-interface within the vsync window (e.g., 16 ms) to provide a jank-free user experience. If there is a relatively large amount of content that needs to be displayed, then the amount of commands may be greater than if there is a relatively small amount of content that needs to be displayed. To ensure that GPU 12 is able to execute the submitted commands within the set time period, controller 30 may adjust the frequency (i.e., clock rate) of the clock signal that oscillator 34 outputs. However, to adjust the clock rate of the clock signal such that the clock rate is high enough to allow GPU 12 to execute the submitted commands within the set time period, controller 30 may receive information indicating whether to increase, decrease, or keep the clock rate of oscillator 34 the same. In some examples, controller 30 may receive information indicating a specific clock rate for the clock signal that oscillator 34 outputs. In the techniques described in this disclosure, frequency management module 32 may be configured to determine the clock rate of the clock signal that oscillator 34 outputs as well as the clock rate of the clock signal that oscillator 44 outputs. Oscillator 44 may be included in computing device 2, such as in CPU 6, in a memory controller (not shown), or elsewhere in computing device 2 to control the operating frequency of memory 10.

In the techniques described in this disclosure, frequency management module 32 may be configured to determine the clock rate of the clock signal that oscillator 34 outputs as well as the clock rate of the clock signal outputted by oscillator 44. Oscillator 44 may be included in computing device 2, such as in CPU 6, in a memory controller (not shown), or elsewhere in computing device 2 to control the operating frequency of memory 10. The clock rate of the clock signal that oscillator 34 outputs may be the operating frequency of GPU 12, and the clock rate of the clock signal that oscillator 44 outputs may be the operating frequency of system memory 10. Together, the pair of the operating frequency of the GPU 12 and the operating frequency of system memory 10 may be considered an OPP.

Frequency management module 32, also referred to as dynamic clock and voltage scaling (DCVS) module, is illustrated as being software executing on CPU 6. However, frequency management module 32 may be hardware external or internal to CPU 6, or a combination of hardware and software or firmware. For example, frequency management module 32 may be firmware of a processing unit other than CPU 6 or GPU 12. Frequency management module 32 may be configured to, for a particular frequency of GPU 12 and a particular frequency of memory 10, given a particular workload of GPU 12, estimate the energy consumption of GPU 12 and memory 10 based on an energy model that calculates an estimated energy consumption given a pair of operating frequency for GPU 12 and operating frequency for memory 10.

As discussed herein, a workload may be a group of commands to be executed by GPU 12. In one example, the commands may be grouped such that a workload may be commands to be executed by GPU 12 to render a single frame. Thus, CPU 6 may determine the upcoming workload for the next interval as the set of commands to be executed by GPU 12 to render an upcoming frame (e.g., the next frame, the frame after the next frame, and the like), and may estimate the performance and energy consumption for the upcoming workload at various OPPs to determine an optimal OPP at which GPU 12 and memory 10 may operate to process the upcoming workload.

Because it may potentially be challenging to accurately predict the upcoming workload, especially for low latency workloads on latency-optimized architectures, CPU 6 may determine the upcoming workload as being similar to a previous workload. Such a previous workload may be immediately previous to the upcoming workload (e.g., determining the workload to render frame N+1 as being similar to the workload to render frame N). In some examples, due to latency in determining workload characteristics, CPU 6 may determine the upcoming workload as being similar to a previous workload that is not immediately previous to the upcoming workload, but is nevertheless temporally close to the upcoming workload (e.g., determining the workload to render frame N+1 as being similar to the workload to render frame N−1). As such, when this disclosure discusses determining workload characteristics for an upcoming workload, it should be understood that it may include determining workload characteristics for a workload that is processed by GPU 12 prior to processing the upcoming workload, and that CPU 6 may determine the upcoming workload to have the same workload characteristics as determined by CPU 6 for the workload that is processed by GPU 12 prior to processing the upcoming workload.

For example, CPU 6 may determine the workload to process an upcoming frame of a video (or any other sequence of image frames) as being similar to the workload to process the frame previous to the upcoming frame in the video (e.g., immediately previous frame to the upcoming frame). Due to temporal locality between the workload, determining the upcoming workload as being similar (or the same) to the immediately previous workload may work well for video and graphical workloads due to a high correlation between consecutive frames of a video.

CPU 6 may characterize a workload based at least in part on workload characteristics, which may be measured by CPU 6. Thus, CPU 6 may determine that an upcoming workload has similar workload characteristics as a previous workload. For example, the workload for GPU 12 to render a next frame of video may have similar workload characteristics as the workload for GPU 12 to render an immediately previous frame of video. Thus, CPU 6 may capture the workload characteristics of GPU 12 and memory 10 as GPU 12 to process commands to render a particular image frame, and may specify the workload to render an upcoming frame as having the same workload characteristics as the workload to render the particular image frame.

Such workload characteristics may include workload dependent events such as the work to be performed by various components of GPU 12, such as the work to be performed by the arithmetic logic units (ALUs) and texture processor of GPU 12. Such workload characteristics may also include the amount of data transfer between GPU 12 and memory 10 as GPU 12 and memory 10 to process the workload. These workload characteristics may be independent of the operating frequencies of GPU 12 and memory 10.

CPU 6 may capture these workload characteristics using performance counters. Performance counter can be any physical register, implemented in hardware or software, operable to store information, including counter values, related to various events related to the GPU system. GPU 12 may include circuitry that increments a counter every time a unit within GPU 12 stores data to and/or reads data from one or more general purpose registers (GPRs), or increments a counter every time specified components within GPU 12 performs a function. In some examples, if multiple components may perform a function during a clock cycle, the counter may increment only once if one or more components perform a function during the clock cycle. At the conclusion of the time interval, CPU 6 may determine the number of times the units within GPU 12 accessed the one or more GPRs or determine the number of times any component with GPU 12 performed a function during the clock cycle. For instance, CPU 6 may determine the difference between counter values at the beginning and end of a time period.

Workload characteristics may include counts of various events inside GPU 12 that are representative of computation (e.g., by the ALUs and texture processor) and data transfer for a specific time period (e.g., at frame granularity) and for a specific workload. Examples of workload characteristics include a number of submissions to GPU 12 and a number of threads/application making submissions to the GPU 12 while processing the workload. These events are representative of the amount of computation by GPU 12 as well as data transfer to and from memory 10 to process the particular workload. In one example, GPU 12 may determine workload characteristics at frame granularity. In other words, GPU 12 may determine the workload of GPU 12 to render one image frame of a video.

In various examples, the workload characteristics may include the time spent on data transfer to/from system memory 10 while processing the particular workload. In various examples, this may include all memory interactions during vertex shading, fragment shading, and texture fetching in processing the workload to render the associated graphic frame. In various examples, the workload statistics include the time spent performing arithmetic logic unit (ALU) operations. In various examples, the workload statistics may include the time spent performing texture sampling operations. In further examples, the workload characteristics may include events that occur within additional other blocks within GPU 12, such as the primitive controller, the triangle processing unit, and the like. These examples are illustrative, and are not intended to in any manner limit the range of system measurements or techniques that could be used by CPU 6 to determine the workload characteristics of GPU 12.

As shown in FIG. 2, GPU 12 may include shader core 36 and fixed-function pipeline 38 that forms an execution pipeline used to perform graphics or non-graphics related functions. Shader core 36 may include ALUs that may be programmed via shader programs to perform graphics processing operations, such as vertex and fragment processing via vertex and fragment shader programs. Shader core 36 may include ALUs that support the Single Instruction Multiple Data (SIMD) processing model, such that each ALU may perform the same operation on multiple pieces of data in parallel. The ALU width, which indicates the number of operations the ALU can perform in parallel, as well as the number of ALUs may correspond to the processing power of GPU 12. Further, shader core 36 and fixed-function pipeline 38 may also include a texture processor as a dedicated hardware block to perform texture related computations.

GPU 12 may perform vertex processing, such as vertex shading, which may involve interacting with system memory 10 or local memory 14 to fetch vertex attributes from system memory 10 or local memory 14, and to save transformed attributes to system memory 10 or local memory 14. Vertex shading may also involve performing ALU operations to transform vertex attributes and to perform vertex attribute computations. Examples of vertex attribute computations may include transforming vertex location from local space to clipping space, and texture coordinate transformation. GPU 12 may perform rasterization of the vertices to create fragments from transformed triangles (vertices), including interpolating fragment attributes such as location and texture coordinate information from the vertices.

GPU 12 may perform fragment processing to processes these fragments. GPU 12 may generally make heavy use of the texture processor in performing fragment processing. During fragment processing, GPU 12 may use texture coordinates to sample texture data, and may use texture data to form the final color and light intensity of the fragment. Texture samplers of the texture processor may process multiple texture elements (texels) and combine them into one data point for the color blending of an individual fragment. Different texture sampling algorithms may require different number of texels per fragment, and, thus, varying amount of data transfer from system memory 10 or local memory 14. The different numbers of texels per fragment may also result in a different numbers of texture related computation as well.

As discussed above, CPU 6 may determine an optimal OPP for GPU 12 and system memory 10 at which GPU 12 and system memory 10 may operate to process an upcoming workload in order to meet performance and energy consumption requirements. CPU 6 may capture workload characteristics, as describe above, for a particular workload, and may determine that an upcoming workload has the same (or similar) workload characteristics as exhibited by GPU 12 processing the particular workload. CPU 6 may utilize the captured workload characteristics to determine an optimal OPP for GPU 12 and system memory 10 to process the upcoming workload such that GPU 12 may meet a performance deadline in processing the workload while minimizing the energy consumed by GPU 12 and system memory 10.

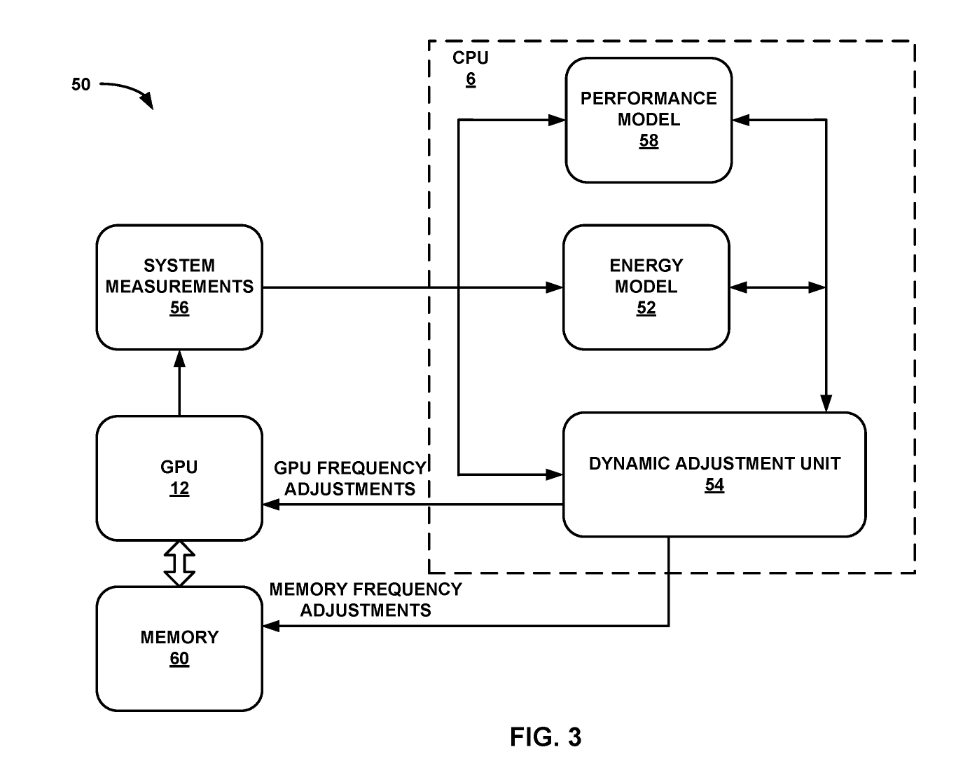

FIG. 3 is a block diagram illustrating an example implementation of a graphics system 50, such as computing device 2 which may determine an optimal OPP at which to operate an example GPU and an example memory to process an example workload. As illustrated in FIG. 3, system 50 may include GPU 12 coupled to system memory 10. In some instances, system memory 10 may also local memory 14 as shown in FIG. 1, or a combination of system memory 10 and local memory 14, or any other suitable memory within computing device 2.

System 50 may select suitable operating frequencies for GPU 12 and memory 10, and may adjust the operating frequencies of GPU 12 and memory 10, so that system 50 may perform workloads in an energy efficient manner while meeting performance deadlines for performing those workloads. By using the combination of performance model 58, energy model 52, and dynamic adjustment unit 54 as described herein, system 50 may reduce the energy consumed to process workloads without affecting the performance of system 50 while processing the workloads. Various example implementations and techniques to achieve these objectives are described herein for combining predicted GPU performance and power consumption levels to achieve optimal power and performance.

System 50 may derive system measurements 56 for a workload from the operation of GPU 12 and memory 10, and may provide system measurements 56 to CPU 6. System measurements 56 may generally include or otherwise correspond to the workload characteristics captured by CPU 6, as described above with respect to FIG. 2. However, it should be understood that system measurements 56 may not be limited to any particular type of system measurements, and may include any suitable measurements, including but not limited to the example measurements described herein, that can be provided as inputs to CPU 6 regarding the performance of GPU 12 and memory 10.

As shown in FIG. 3, system 50 may provide system measurements 56 to performance model 58, to energy model 52, and/or to dynamic adjustment unit 54, each of which may be logic and/or circuitry to perform functions that are described herein. In various examples, each of performance model 58, energy model 52, and dynamic adjustment unit 54 may be executed by CPU 6. In various examples, one or more of performance model 58, energy model 52, and dynamic adjustment unit 54 may be provided at least in part as hardware circuits within computing device 2.

In various examples, performance model 58 may be operable to provide information on the relevant performance level combinations of the operating frequencies of GPU 12 and memory 10, and can be used to determine if a given combined level of a particular GPU operating frequency for GPU 12 and a particular memory operating frequency for memory 10 will meet a set of system performance requirements (i.e., a performance deadline). CPU 6 may execute performance model 58 to compare actual timelines for a given workload or task to timeline estimates for the same workload or task. Performance model 58 may be developed based on a model of the GPU system to which performance model 58 is to be applied, and may in general be based at least in part on how the blocks of system 50 are fit together. Estimates for times to complete various workloads on system 50 can be obtained by running the performance model of a given workload or task with various sets of operating frequencies for the GPU and the DDR to determine what the OPP points are for these sets of operating frequencies. In some examples, performance model 58 may be consistent for a given workload, but may not necessarily exactly match the actual measured time that GPU 12 is running, and in such examples provides a likelihood (probability) that given combination of GPU operating frequency and memory operating frequency will be successful at meeting the system performance requirements.

Performance model 58 may identify one or more OPPs from a set of OPPs at which GPU 12 and memory 10 may operate to meet the performance deadline to process a particular workload, based at least in part on system measurements 56 associated with each of the set of OPPs. In various examples, energy model 52 is operable to provide power estimates for each combined level of GPU and memory operating frequencies of interest. As with the performance model 58, in various examples energy model is an estimate of energy consumption for these proposed combinations of GPU and memory operating frequencies. Specifically, energy model 52 may determine estimated energy consumption for GPU 12 and memory 10 while operating at each of the one or more OPPs identified by performance model 58 to process the particular workload. In some examples, energy model 52 may identify an optimal OPP, which may be the OPP out of the one or more OPPs at which GPU 12 and memory 10 operates to consume the least amount of energy to process the particular workload.

In various examples, the dynamic adjustment unit 54 provides a core of system 50. The dynamic adjustment unit 54 is operable to determine which combination of proposed operating frequencies (OPPs) at which GPU 12 and memory 10 should operate based at least in part on information derived from one or both of performance model 58 and energy model 52. Dynamic adjustment unit 54 may also responsible for selecting the operating levels (e.g., OPPs) to apply as the operating frequencies for the GPU 12, for the memory 10, or both the GPU 12 and the memory 10, and is responsible for error correction if the yielded performance based on these applied operating frequencies is insufficient to meet the system performance requirements. Dynamic adjustment unit 54 may be responsible for adjusting operating frequencies of GPU 12 and/or memory 10 to larger workload changes. Dynamic adjustment unit 54 may further be operable to determine if a more optimal operating point (OPP) can be located that still meets the system performance requirements when the GPU 12 and memory 10 have been operating at a stable workload level for some period of time. For example, dynamic adjustment unit 54 may set the operating frequencies of GPU 12 and memory 10 to the optimal OPP as determined by energy model 52.

Aspects of this disclosure includes creating a set of statistically derived equations for energy model 52 to determine an estimated energy consumption for GPU 12 and memory 10 for a workload given a pair of operating frequency for GPU 12 and operating frequency for memory 10. energy model 52 does not have to be exact in its estimations. Rather, fidelity across OPPs may be potentially more important as the energy model may be used to determine the estimated energy consumption of the system at different OPPs in order to select the most energy efficient OPP.

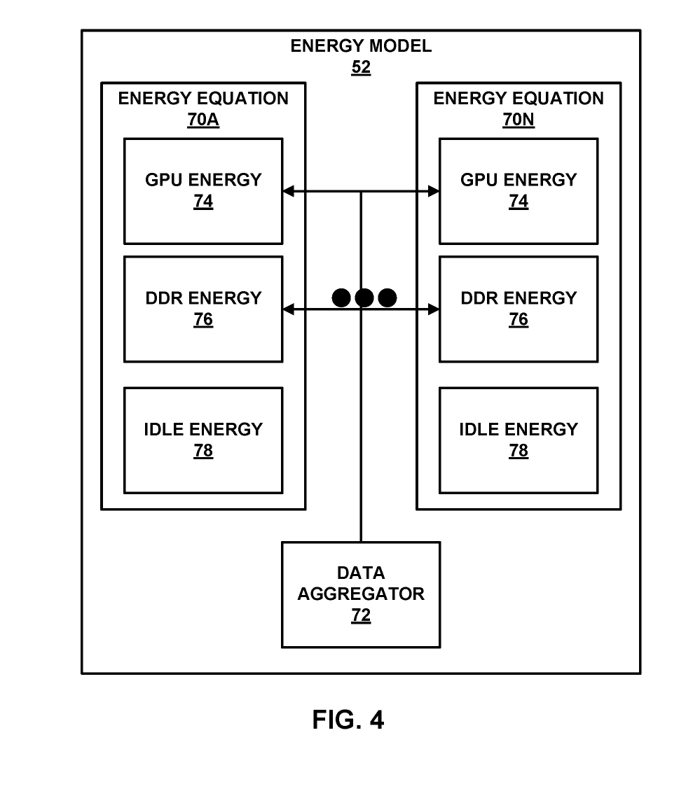

FIG. 4 is a block diagram illustrating an exemplary energy model 52 that frequency management module 32 shown in FIG. 2 may utilize to determine estimated energy consumption for GPU 12 and memory 10 operating according to various operating frequencies. Given inputs of workload characteristics for an upcoming workload and an OPP that includes a GPU frequency and a memory frequency, CPU 6 may execute energy model 52 to determine an estimated energy consumption by GPU 12 and memory 10 running at the respective GPU frequency and memory frequency to process the upcoming workload based at least in part on the workload characteristics of the upcoming workload. Specifically, CPU 6 may predict the workload characteristics of an upcoming workload according to techniques disclosed throughout this disclosure, and may determine the estimated energy consumption of GPU 12 and memory 10 running at various operating frequencies to process the upcoming workload having the predicted workload characteristics.

Such workload characteristics may include workload dependent events such as the work to be performed by various components of GPU 12, such as the work to be performed by the arithmetic logic unit (ALU) and texture unit of GPU 12. Such workload characteristics may also include the amount of data transfer between GPU 12 and memory 10 as GPU 12 and memory 10 to process the workload. These workload characteristics may be independent of the operating frequencies of GPU 12 and memory 10.

In general, these workload characteristics events may be categorized as characteristics of the workload to be performed by the arithmetic logic unit (ALU) and texture unit of GPU 12, as well as the amount of data transfer between GPU 12 and memory 10 as GPU 12 and memory 10 processes the workload. Energy model 52 may include data aggregator 72 that integrates these workload characteristics as workload dependent events into three components: read/write load, arithmetic logic unit load, and texture unit load. Such workload dependent events may be workload events (e.g., workload to be processed by GPU 12 and data to be transferred between GPU 12 and memory 10) that are independent of the operating frequencies of GPU 12 and memory 10. The arithmetic logic unit load and texture unit load components may represent the amount of computation by GPU 12 to process the particular workload, while the memory read/write load component may represent the amount of data communications between GPU 12 and memory 10 in the particular workload.

As shown in FIG. 4, energy model 52 may include energy equations 70A-70N (hereafter “energy equations 70”) for a plurality of OPPs. Energy model 52 may include a separate energy equation for each OPP, and CPU 6 may utilize the energy equation out of energy equations 70 that is associated with a particular OPP to determine an estimated energy consumption for the particular OPP.

For a particular OPP, the estimated energy consumption may be the sum of GPU energy consumption 74, memory energy consumption 76, and idle energy consumption 78 while GPU 12 and memory 10 operates at the frequencies specified by the OPP. In other words, CPU 6 may determine the estimated energy consumption for a particular OPP and a particular workload as the sum of GPU energy consumption 74, memory energy consumption 76, and idle energy consumption 78.

GPU energy consumption 74 may be determined based at least in part on the workload characteristics of the workload that are associated with GPU 12. In particular, GPU energy consumption 74 may be based at least in part on the arithmetic logic unit load and the texture unit load components of the workload aggregated by data aggregator 72. In addition, GPU energy consumption 74 may also be based at least in part on OPP dependent data, such as power and performance.

Memory energy consumption 76 may be determined based at least in part on the workload characteristics of the workload that are associated with memory 10. In particular, memory energy consumption 76 may be based at least in part on the read/write load component of the workload aggregated by data aggregator 72. In addition, memory energy consumption 76 may also be based at least in part on OPP dependent data, such as power and performance.

Idle energy consumption 78 may be a function of the energy consumption during frame idle time, which may be estimated based on the amount of energy consumed by GPU 12 and memory 10 during sleep time as well as the power savings related to inter-frame power collapse during frame idle time. Specifically, idle energy consumption without power savings related to inter-frame power collapse during frame idle time may be used as the initial idle energy consumption basis. CPU 6 may deduct the amount of energy savings the various power saving techniques can provide from this base value to determine idle energy consumption 78. A potential strength of this approach is that it can model the existence or absence of energy saving techniques for idle energy across chipset variations, and that the model may be adjustable at runtime when those techniques are enabled/disabled.

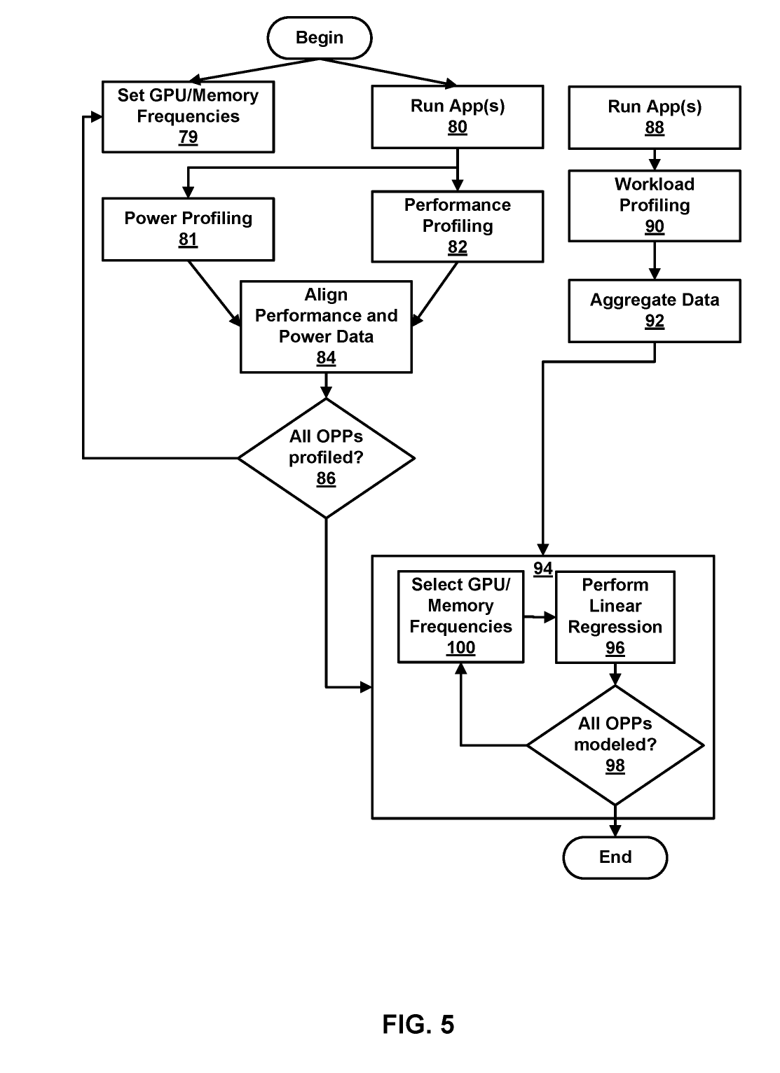

Energy model 52 may include a separate energy equation for each OPP. Having one energy equation out of energy equations 70 per OPP may remove the non-linear relationship that exists between energy consumption and GPU/DDR frequency (and voltage), to result in a more simplified and accurate energy model 52. CPU 6 may generate energy model 52 that includes energy equations 70 via an automation methodology, which will be described later with respect to FIG. 5, and such energy model generation may become feasible as a result of simplification and linearization of the model. As a result, CPU 6 may use energy model 52 to estimate energy levels that are much more accurate than the results of a single model that uses GPU and DDR frequencies (and voltages) variables in the equation.

Specifically, because energy model 52 includes a separate energy equation per OPP, CPU 6 may utilize energy model 52 to identify when running faster (i.e., operating GPU 12 and memory 10 at higher clock rates) may be more energy efficient. To better illustrate why having a separate energy equation per OPP may enable CPU 6 to identify cases in which running faster is more energy efficient, consider the case where a single energy equation is used for all OPPs:

Energy=β_{DDR}*DDRFreq+β_{GPU}*GPUFreq+β₁*P₁ . . . βₙ*Pₙ+Intercept (1)

If energy model 52 had a single equation (e.g., equation (1)) across the OPPs rather than one equation per OPP, the equation would be in the above form. Note that GPU and DDR frequencies are predictors in the model. Pᵢ, i=1 . . . n, may be workload dependent events (e.g., workload characteristics) that contribute to the total energy. βi may all be positive. In general, we expect β_{gpu} and β_{ddr} to be positive, as energy consumption on may typically increase with frequency (and voltage) increase.

Consequently, using equation (1) to identify the most energy efficient memory frequency for a given GPU frequency may potentially always return the lowest DDR frequency. Thus, such an energy equation may not be used to identify scenarios where energy may be conserved by staying at higher frequencies (thereby improving both energy efficiency and performance simultaneously).

In contrast, each of energy equations 70 of energy model 52 may have a similar but separate equation, but without the GPU_{Freq} and DDR_{Freq} terms:

Energy=Σβᵢ*Pᵢ+Intercept (2)

As can be seen, equation (2) may only include linear terms, such that the coefficients are finely tuned and the predictions are much more accurate. The fine-tuned models as represented by equation (2) can be used to accurately recognize when running at higher frequency OPP is more energy efficient. In other words, each of energy equations 70 does not include the GPU frequency and the memory frequency as independent variables in the equation.

In equation (2), βᵢ are coefficients and Pᵢ are model parameters. The model parameters may correspond with the workload dependent events aggregated by data aggregator 72. Specifically, the workload characteristics of a particular workload, as aggregated by data aggregator 72 into read/write load, arithmetic logic unit load, and texture unit load may be plugged into equation (2) for a particular OPP to determine an estimated energy consumption for GPU 12 and memory 10 operating according to the particular OPP.

In some examples, each of energy equations 70 may, in addition to the model parameters that correspond with workload dependent events, further include independent variables that correspond with the number of active processing cores of GPU 12, such as the number of active cores of shader core 36, the number of active cores of texture units/processors of GPU 12, and the like. Further, in some examples, each of energy equations 70 may also include independent variables that correspond with the cache or local memory sizes.

Given a particular workload, CPU 6 may, based on energy equations 70, determine, for each of a plurality of OPPs identified by performance model 58 as meeting the performance deadline to process a particular workload, an estimated energy consumption associated with memory 10 and GPU 12 operating according to the particular OPP to process the workload. CPU 6 may, based at least in part on the estimated energy consumption, set memory 10 and GPU 12 to operate at a respective memory frequency and GPU frequency of one of the plurality of OPPs to process the workload.

In particular, CPU 6 may determine the OPP that is associated with the lowest energy consumption for memory 10 and GPU 12 to process the workload out of the plurality of OPPs, and may set memory 10 and GPU 12 to operate according to the determined OPP. In this way, CPU 6 may enable GPU 12 and memory 10 to process a particular workload to meet a performance deadline while minimizing energy consumption.

FIG. 5 is a flowchart illustrating an example automated energy model generation methodology to generate energy equations 70 for energy model 52. The modular design of energy model 52 as illustrated in FIG. 4 may implicitly play an important role in automating the energy model generation process by simplifying and linearizing the equations, thereby potentially eliminating the need for manual, ad-hoc tweaking to obtain an accurate energy model 52.

Generating energy equations 70 may include generating a set of model parameters for energy equations 70. The same model parameters may not necessarily be effectively used for different variations of a chipset across multiple chipset variations. The automated energy model generation methodology to generate energy equations 70 for energy model 52 as shown in FIG. 5 may enable fine tuning of the model parameters across the chipset variations in a reasonable time-frame.

As shown in FIG. 5, a testing device, such as CPU 6, or any other processors, including processors, systems, and devices external to GPU 12, CPU 6, or computing device 2, may perform profiling of the energy consumption characteristics of GPU 12 and memory 10 to determine a separate energy consumption equation for each of a plurality of OPPs. Specifically, the test processor may perform a first pass to align performance and power data at a variety of OPPs, and then perform a second pass to extract a set of workload characteristics to perform linear regression to generate energy equations 70 for a plurality of OPPs based on the aligned performance and power data and the workload characteristics.

As part of the first pass of model generation, the testing device may cycle through each of a plurality of OPPs by setting the operating frequencies of GPU 12 and memory 10 according to a particular OPP (79), which may be one of a plurality of OPPs that the host processor cycles through. While GPU 12 and memory 10 operates at this particular OPP, the testing device may issue one or more workloads (i.e., sets of commands to be executed by GPU 12) to GPU 12 (80). As GPU 12 and memory 10 processes the workloads, CPU 6 may perform power profiling (81) to profile the energy consumption of GPU 12 and memory 10 while processing the issued workloads at the particular OPP, and may also perform performance profiling (82) to profile the performance of GPU 12 and memory 10 while processing the issued workloads at the particular OPP. The testing device may capture performance data of GPU 12 and memory 10 via performance counters. These performance counters may count the number of commands processed by the GPU 12 in a given period (e.g., per frame), the number of ALU operations performed by GPU 12 in the given period, the number of texture sampling operations performed by GPU 12 in the given period, the number of memory reads and writes in the given period, and the like.

The testing device may, based on data collected as part of the power profiling and performance profiling, align the power and performance data collected (84) for the particular OPP to correlate the energy consumption of GPU 12 and memory 10 operating according to the particular OPP with the performance of GPU 12 and memory 10 operating according to the particular OPP, and may thereby extract per-frame total energy consumption of GPU 12 and memory 10 at the particular OPP.

The testing device may perform such profiling for a plurality of OPPs that include different sets of GPU and memory frequencies, such that CPU 6 may determine whether each of a plurality of OPPs have been profiled (86). If any remaining OPPs of the plurality of OPPs have not yet been profiled, the testing device may circle back to perform steps 79, 80, 81, 82, and 84, for each of the remaining unprofiled OPPs.

As part of the second pass of energy model generation, the testing device may capture workload dependent events that are independent of the operating frequencies of GPU 12 and memory 10, such as via use of performance counters. These workload dependent events may be representative of the amount of computation performed by GPU 12 as well as data transfers by GPU 12 to and from memory 10. For example, these workload dependent events may be the workload characteristics discussed above with respect to FIGS. 2-4, and may include data indicative of the workload to be performed by the arithmetic logic unit (ALU) and texture unit of GPU 12, as well as the amount of data transfer between GPU 12 and memory 10 as GPU 12 and memory 10 processes the workload. Specifically, the workload dependent events that may be captured by the testing device may be similar to that of the data aggregated by data aggregator 72 shown in FIG. 4, such as read/write load, arithmetic logic unit load, and texture unit load between GPU 12 and memory 10 in the particular workload.

As shown in FIG. 5, the testing device may cycle through each of a plurality of OPPs by setting the operating frequencies of GPU 12 and memory 10 according to a particular OPP out of a plurality of OPPs While GPU 12 and memory 10 operates at this particular OPP, the testing device may issue one or more workloads (i.e., sets of commands to be executed by GPU 12) to GPU 12 (88).

As GPU 12 and memory 10 processes the workloads, the testing device may perform workload characteristics profiling (90) to extract, from the workloads issued by the testing device, workload dependent events and characteristics, as described above, as aggregate data (92), including read/write load, arithmetic logic unit load, and texture unit load between GPU 12 and memory 10 at the particular OPP.

The testing device may perform energy model generation (94) to generate an energy equation for the particular OPP, which determines an estimated energy consumption for GPU 12 and memory 10 operating at the particular OPP. The testing device may, based on the extracted aggregate data and the aligned power measurement/performance data as well as the extracted workload dependent events, perform linear regression (96) to generate an energy equation for the particular OPP.

Performing linear regression may include fitting the extracted aggregate data and the aligned power measurement/performance data as well as the extracted workload dependent events to generate an energy equation in the form ofEnergy=Σβᵢ*Pᵢ+Intercept, where βᵢ are coefficients and Pᵢ are model parameters. The model parameters for the energy equation may correlate to or otherwise correspond with the extracted workload dependent events. Thus, CPU 6 may, for a particular OPP, utilize the energy equation for the particular OPP to determine an estimated energy consumption for GPU 12 and memory 10 operating at the particular OPP to process a workload based at least in part on the workload characteristics of the workload.

Note that the energy equation does not include the operating frequencies of GPU 12 or memory 10 as dependent variables. Thus, while an OPP is associated with a particular energy equation to determine the energy consumption for GPU 12 and memory 10 operating at the particular OPP to process a workload, the actual values of the GPU frequency and memory frequency pair making up the particular OPP are not used as a part of the energy equation.

In addition, generating energy model 52 includes generating a separate energy equation for each of a plurality of OPPs. Thus, while each energy equation for an OPP may be in the form of Energy=Σβᵢ*Pᵢ+Intercept, the coefficients and model parameters of each of the separate energy equations may be different.

In other examples, CPU 6 may use any other suitable technique for generating energy model 52. For example, CPU 6 may utilize techniques such as performing statistical analysis and modeling, applying artificial intelligence, employing machine leaning to generate energy model 52 based on profile data (offline) as well as runtime (online) measurements.

After generating the energy equation for an OPP, the testing device may determine whether it has generated a separate energy equation for each of the plurality of OPPs (98), thereby modeling the plurality of OPPs. If testing device has not yet generated energy equations for any remaining OPPs of the plurality of OPPs, the testing device may select a remaining OPP (100) and circle back to perform steps 88, 90, 92, and 94, for each of the remaining OPPs.

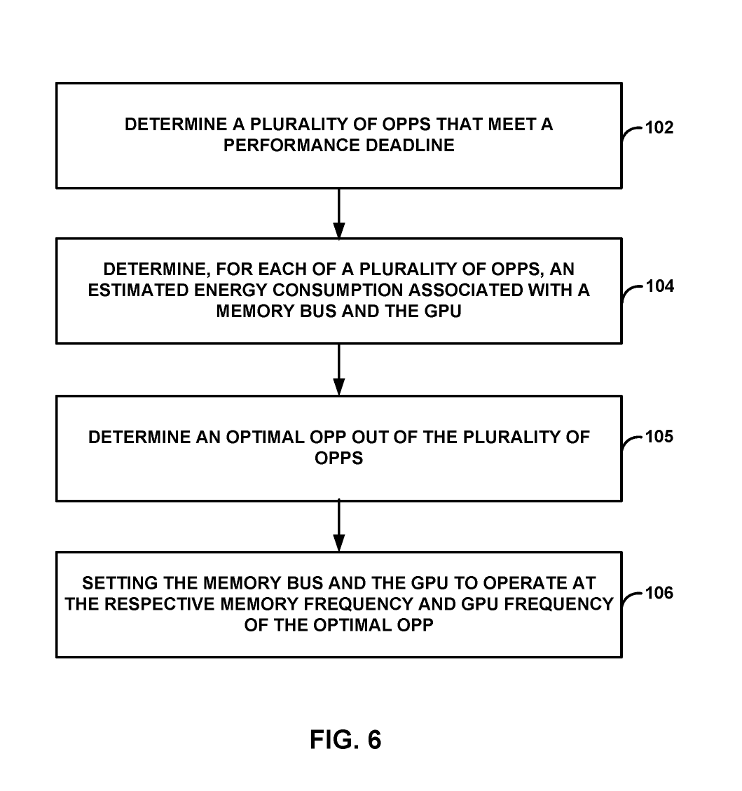

FIG. 6 is a flowchart illustrating a process for estimating energy consumption by GPU 12 and memory 10. As shown in FIG. 6, the process may include determining, by a host processor such as CPU 6, a plurality of operating performance points (OPPs) that each comprise a memory frequency and a graphics processing unit (GPU) frequency that meet a performance deadline (102). In some examples, CPU 6 may determine the plurality of OPPs by using a performance model 58.

The process may further include determining, by a host processor such as CPU 6, for each of the plurality of OPPs, an estimated energy consumption associated with a memory 10 and the GPU 12 operating at the respective memory frequency and GPU frequency to process a workload based at least in part on a plurality of energy equations 70 associated with the plurality of OPPs (104). The process may further include determining an optimal OPP out of the plurality of OPPs based at least in part on determining the estimated energy consumption for each of the plurality of OPPs (105). The process may further include setting the memory 10 and the GPU 12 to operate at the respective memory frequency and GPU frequency of one of the plurality of OPPs to process the workload based at least in part on the estimated energy consumption (106).

In some examples, setting the GPU 12 and the memory 10 may further include determining an OPP associated with a lowest estimated energy consumption out of the energy consumption associated with the memory 10 and the GPU 12 operating at the respective memory frequency and GPU frequency to process the workload for each of the plurality of OPPs, and setting the memory 10 and the GPU 12 to operate the respective memory frequency and GPU frequency of the OPP to process the workload.

In some examples, each one of the plurality of energy equations is associated with one of the plurality of OPPs. In some examples, the plurality of energy equations do not include the GPU frequency and the memory frequency as independent variables. In some examples, determining, for each of the plurality of OPPs, the estimated energy consumption is further based at least in part on workload characteristics of the workload. In some examples, the plurality of energy equations each include one or more independent variables associated with the workload characteristics of the workload.

In some examples, the workload characteristics comprise one or more of: arithmetic logic unit load, texture unit load, or memory read/write load. In some examples, the workload comprises an upcoming workload, and the process may further include setting previous workload characteristics of a previous workload as the workload characteristics of the upcoming workload. In some examples, the previous workload comprises a first set of commands to be executed by the GPU 12 to render a previous image frame of a video, and the upcoming workload comprises a second set of commands to be executed by the GPU 12 to render an upcoming image frame of the video.

In some examples, the process may further include generating the plurality of energy equations for the plurality of OPPs based at least in part by performing power profiling and performance profiling for each of the plurality of OPPs. In some examples, generating the plurality of energy equations may further include performing linear regression to generate the plurality of energy equations based at least in part on a plurality of workload characteristics as well as underlying hardware characteristics.

In one or more examples, the functions described may be implemented in hardware, software, firmware, or any combination thereof. If implemented in software, the functions may be stored on, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

This disclosure also includes attached appendices, which forms part of this disclosure and is expressly incorporated herein. The techniques disclosed in the appendices may be performed in combination with or separately from the techniques disclosed herein.

Various examples have been described. These and other examples are within the scope of the following claims.

What is claimed is:

1. A method comprising:
determining, by at least one processor for each of a plurality of operating performance points (OPPs) that each comprise a memory frequency and a graphics processing unit (GPU) frequency, an estimated energy consumption associated with a memory and a GPU operating at the respective memory frequency and GPU frequency to process a workload based at least in part on a plurality of energy equations associated with the plurality of OPPs; and
setting the memory and the GPU to operate at the respective memory frequency and GPU frequency of one of the plurality of OPPs to process the workload based at least in part on the estimated energy consumption.

2. The method of claim 1, further comprising:
determining an OPP associated with a lowest estimated energy consumption out of the energy consumption associated with the memory and the GPU operating at the respective memory frequency and GPU frequency to process the workload for each of the plurality of OPPs;
setting the memory and the GPU to operate at the respective memory frequency and GPU frequency of the OPP to process the workload.

3. The method of claim 1, wherein each one of the plurality of energy equations is associated with one of the plurality of OPPs.

4. The method of claim 3, wherein the plurality of energy equations do not include the GPU frequency and the memory frequency as independent variables.

5. The method of claim 4, wherein determining, for each of the plurality of OPPs, the estimated energy consumption is further based at least in part on workload characteristics of the workload.

6. The method of claim 5, wherein the plurality of energy equations each include one or more independent variables associated with the workload characteristics of the workload.

7. The method of claim 5, wherein the workload characteristics comprises one or more of: arithmetic logic unit load, texture unit load, or memory read/write load.

8. The method of claim 5, wherein the workload comprises an upcoming workload, further comprising:
setting previous workload characteristics of a previous workload as the workload characteristics of the upcoming workload.

9. The method of claim 8, wherein:
the previous workload comprises a first set of commands to be executed by the GPU to render a previous image frame of a sequence of image frames; and
the upcoming workload comprises a second set of commands to be executed by the GPU to render an upcoming image frame of the sequence of image frames.

10. The method of claim 1, further comprising:
generating the plurality of energy equations for the plurality of OPPs based at least in part by performing power profiling and performance profiling for each of the plurality of OPPs.

11. The method of claim 10, wherein generating the plurality of energy equations further comprises:
performing linear regression to generate the plurality of energy equations based at least in part on a plurality of workload characteristics.

12. A device comprising:
a graphics processing unit (GPU);
a memory operably coupled to the GPU; and
at least one processor configured to:
determine, for each of a plurality of operating performance points (OPPs) that each comprise a memory frequency and a GPU frequency, an estimated energy consumption associated with the memory and the GPU operating at the respective memory frequency and GPU frequency to process a workload based at least in part on a plurality of energy equations associated with the plurality of OPPs; and
set the memory and the GPU to operate at the respective memory frequency and GPU frequency of one of the plurality of OPPs to process the workload based at least in part on the estimated energy consumption.

13. The device of claim 12, wherein the at least one processor is further configured to:
determine an OPP associated with a lowest estimated energy consumption out of the energy consumption associated with the memory and the GPU operating at the respective memory frequency and GPU frequency to process the workload for each of the plurality of OPPs; and
set the memory and the GPU to operate at the respective memory frequency and GPU frequency of the OPP to process the workload.

14. The device of claim 13, wherein the plurality of energy equations do not include the GPU frequency and the memory frequency as independent variables.

15. The device of claim 14, wherein determining, for each of the plurality of OPPs, the estimated energy consumption is further based at least in part on workload characteristics of the workload.

16. The device of claim 15, wherein the plurality of energy equations each include one or more independent variables associated with the workload characteristics of the workload.

17. The device of claim 16, wherein the workload characteristics comprises one or more of: arithmetic logic unit load, texture unit load, or memory read/write load.

18. The device of claim 16, wherein the workload comprises an upcoming workload, and wherein the at least one processor is further configured to:
set previous workload characteristics of a previous workload as the workload characteristics of the upcoming workload.

19. The device of claim 18, wherein:
the previous workload comprises a first set of commands to be executed by the GPU to render a previous image frame of a sequence of image frames; and
the upcoming workload comprises a second set of commands to be executed by the GPU to render an upcoming image frame of the sequence of image frames.

20. The device of claim 12, wherein the device comprises at least one of:
an integrated circuit;
a system on a chip;
a microprocessor; and
a wireless communication device.

21. An apparatus comprising:
means for determining, for each of a plurality of operating performance points (OPPs) that each comprise a memory frequency and a graphics processing unit (GPU) frequency, an estimated energy consumption associated with a memory and a GPU operating at the respective memory frequency and GPU frequency to process a workload based at least in part on a plurality of energy equations associated with the plurality of OPPs; and
means for setting the memory and the GPU to operate at the respective memory frequency and GPU frequency of one of the plurality of OPPs to process the workload based at least in part on the estimated energy consumption.

22. The apparatus of claim 21, further comprising:
means for determining an OPP associated with a lowest estimated energy consumption out of the energy consumption associated with the memory and the GPU operating at the respective memory frequency and GPU frequency to process the workload for each of the plurality of OPPs;
means for setting the memory and the GPU to operate the respective memory frequency and GPU frequency of the OPP to process the workload.

23. The apparatus of claim 21, wherein each one of the plurality of energy equations is associated with one of the plurality of OPPs.

24. The apparatus of claim 23, wherein the plurality of energy equations do not include the GPU frequency and the memory frequency as independent variables.

25. The apparatus of claim 24, wherein the means for determining, for each of the plurality of OPPs, the estimated energy consumption is further based at least in part on workload characteristics of the workload.

26. A non-transitory computer-readable storage medium comprising instructions that, when executed on at least one processor, causes the at least one processor to:
determine, for each of a plurality of operating performance points (OPPs) that each comprise a memory frequency and a graphics processing unit (GPU) frequency, an estimated energy consumption associated with a memory and a GPU operating at the respective memory frequency and GPU frequency to process a workload based at least in part on a plurality of energy equations associated with the plurality of OPPs; and
set the memory and the GPU to operate at the respective memory frequency and GPU frequency of one of the plurality of OPPs to process the workload based at least in part on the estimated energy consumption.

27. The non-transitory computer-readable storage medium of claim 26, wherein the plurality of energy equations do not include the GPU frequency and the memory frequency as independent variables.

28. The non-transitory computer-readable storage medium of claim 27, wherein determine, for each of the plurality of OPPs, the estimated energy consumption is further based at least in part on workload characteristics of the workload.

29. The non-transitory computer-readable storage medium of claim 28, wherein the plurality of energy equations each include one or more independent variables associated with the workload characteristics of the workload.

30. The non-transitory computer-readable storage medium of claim 29, wherein the workload characteristics comprises one or more of: arithmetic logic unit load, texture unit load, or memory read/write load.
